(19) United States
(12) Patent Application Publication
(10) Pub. No.: US 2003/0223761 A1
(43) Pub. Date: Dec. 4, 2003

(54) Embedded operational channel network management

(76) Inventors: Brian Robert Brown, Collaroy (AU); Michael Hudson, Chester Hill (AU); Ross Halgren, Collaroy Plateau (AU); Stephen Winnall, Wollstonecraft (AU); Mark Henry Bonwick, Frenchs Forrest (AU); Chia Seiler, Bairnsdale (AU)

Correspondence Address: CHRISTIE, PARKER & HALE, LLP, 350 WEST COLORADO BOULEVARD, SUITE 500, PASADENA, CA, 91105, US

(21) Appl. No.: 10/160,443

(22) Filed: May 31, 2002

(51) Int. Cl. H04B 10/04

(52) U.S. Cl. 398/183

(57) ABSTRACT

A network element for use in a multi-protocol WDM network, the network element comprising a rate multiplying encoding unit for applying a rate multiplying line code to an electrical transmit data signal prior to conversion of the electrical transmit data signal into an optical WDM channel data signal, a rate dividing decoding unit for applying a corresponding rate dividing line code to an electrical receive data signal converted from a received optical WDM channel data signal, and a management unit arranged, in use, to generate an embedded operational channel (EOC) signal in a portion of a bandwidth of the WDM channel for transmission of network management data, wherein the encoding unit is arranged such that, in use, the rate multiplying line code is not applied if the electrical transmit data signal is of a protocol satisfying a threshold condition and is applied if the electrical transmit data signal is of a protocol not satisfying the threshold condition, wherein the decoding unit is arranged such that, in use, the corresponding rate dividing line code is not applied to WDM channel data signals originating from electrical transmit data signals satisfying the threshold condition and is applied to WDM channel data signals originating from electrical transmit signals not satisfying the threshold condition, and wherein the threshold condition is based on interference between the EOC channel signal and the WDM channel data signals.

### FIELD OF THE INVENTION

The present invention relates broadly to a network element for use in a multi-protocol wavelength division multiplex (WDM) network, to a WDM network incorporating such a network element, and to a method of embedding an optical management channel in a WDM channel of an optical network.

### BACKGROUND OF THE INVENTION

WDM telecommunication networks (whether dense WDM or coarse WDM) have the attribute that native signals of virtually any format, protocol or data rate can be sent over different wavelengths. In principle, client interfaces to WDM channels can be optimised for a single format, protocol and data rate. However, such an approach would lead to the design of a large number of client electro-optic interfaces to WDM networks, to cater for the above mentioned range of bit-rates and protocols. To achieve a high flexibility, a large number of spare holdings would be required and physical exchanges would have to take place where bit-rates and/or protocols are to be changed for a particular client interface.

It has been proposed in co-pending U.S. patent application entitled “Jitter control in optical network”, application Ser. No. 10/145,590, filed on May 13, 2002 and assigned to the assignee of the present application to provide an electro-optic interface structure for use in a multi-protocol OEO WDM network, which comprises a rate multiplying encoding unit for applying a rate multiplying line code to an electrical (client) data signal prior to conversion of the electrical data signal into an optical WDM channel signal, and a rate dividing decoding unit for applying a corresponding rate dividing line code to an electrical data signal converted from a received optical WDM channel signal, wherein the encoding unit is arranged such that the same rate multiplying line code can be applied to electrical data signals of different protocols, and wherein the decoding unit is arranged such that, in use, the application of the same corresponding rate dividing line code can create electrical signals of different protocols.

Such a design can support and meet transmission requirements and associated jitter specifications of a wide range of different protocols and data rates on the same client electro-optic interface to a WDM multiplexer, and for supporting a wider range of protocols and data rates in a WDM network.

In WDM networks, network management is typically provided utilising an optical management channel for distribution of management data, as opposed to client traffic data, throughout the network. In dense WDM networks, the optical management channel is typically provided on one of the WDM channels exclusively, i.e. that channel is not used for client data transfer. In coarse WDM networks, however, WDM channel numbers are small and thus exclusive use of one WDM channel as a management channel is not efficient. Rather, in coarse WDM networks, the optical management channel is typically embedded in one of the WDM channels, i.e. that channel is used for both client data and management data transmission.

To reduce interference between the management data signal and the client data signal on the same WDM channel, it has been proposed, e.g. in the abovementioned U.S. patent application, to apply a rate multiplying line code (in the electrical domain) to the client data signal to reduce its low frequency spectral power density and “free” up that spectral range for an embedded optical channel (EOC) with narrow bandwidth and centred around a frequency much less than the (multiplied) maximum frequency of the client data signal.

However, it has been recognised by the applicant that the application of rate multiplying line codes requires significant processing power, with the power requirements increasing as the frequency of the “original” client data signal increases. This in turn leads to thermal problems in the design of network elements for such optical networks. More particularly, where a network element is to be located in an outside plant (OSP) environment, the thermal management of the excess heat generated was found to be a significant problem where the rate multiplying line code was to be applied to multi-protocol client data up to OC3, OC12, and even OC48.

In at least preferred embodiments, the present invention seeks to provide an EOC network management design suitable for implementation in an OSP environment.

### SUMMARY OF THE INVENTION

In accordance with a first aspect of the present invention there is provided a network element for use in a multi-protocol WDM network, the network element comprising a rate multiplying encoding unit for applying a rate multiplying line code to an electrical transmit data signal prior to conversion of the electrical transmit data signal into an optical WDM channel data signal, a rate dividing decoding unit for applying a corresponding rate dividing line code to an electrical receive data signal converted from a received optical WDM channel data signal, and a management unit arranged, in use, to generate an embedded operational channel (EOC) signal in a portion of a bandwidth of the WDM channel for transmission of network management data, wherein the encoding unit is arranged such that, in use, the rate multiplying line code is not applied if the electrical transmit data signal is of a protocol satisfying a threshold condition and is applied if the electrical transmit data signal is of a protocol not satisfying the threshold condition, wherein the decoding unit is arranged such that, in use, the corresponding rate dividing line code is not applied to WDM channel data signals originating from electrical transmit data signals satisfying the threshold condition and is applied to WDM channel data signals originating from electrical transmit signals not satisfying the threshold condition, and wherein the threshold condition is based on interference between the EOC channel signal and the WDM channel data signals.

Preferably, the threshold condition is based on a determination of overlap areas between power density spectra of the EOC signal and the respective WDM channel data signals.

The threshold condition may be based on first ratios of power in the EOC signal and in said respective overlap areas, and second ratios of the respective powers in the unencoded WDM data signals and in said respective overlap areas.

The threshold condition may comprise the electrical transmit data signals having a bit rate equal to or lower than the bit rate of a threshold protocol.

In one embodiment, the network element comprises a laser element for generating the WDM channel signals, and the management unit comprises means for generating an electrical management data signal, and the interface structure is arranged, in use, to combine the electrical transmit data signal with the electrical management data signal and to drive the laser element with the combined electrical signal.

Preferably, the management unit is further arranged, in use, to extract an EOC signal from a WDM channel signal received at the network element. The management unit may comprise a tap unit for extracting the EOC signal. The tap unit may comprise an optical tap element disposed in a manner such that, in use, a portion of the received WDM channel signal is tapped off for extracting the EOC signal.

The tap unit may comprise an electrical tap element disposed in a manner such that, in use, a portion of the electrical receive signal converted from the WDM channel signal is tapped off for extracting the EOC signal.

In one embodiment, the management unit further comprises a k-bit status register unit for generating k-bit status words for transmission in the EOC signal and for reading k-bit status words received in the EOC signal.

The management unit may further comprise a codeword multiplexing unit for selectively generating a management data codeword incorporating the management data or a status codeword incorporating one k-bit status word for transmission on the EOC and a codeword demultiplexing unit for selectively extracting a management data codeword or a status codeword word from the EOC signal.

The management unit may further be arranged such that, in use, a forward error correction (FEC) process is applied to the management data prior to generation of the EOC channel signal and to the received EOC signal.

The management unit may further be arranged such that, in use, an EOC rate multiplying line code is applied to the management data prior to generation of the EOC channel signal and such that an EOC rate dividing line code is applied to the received EOC signal.

Preferably, the network element is capable of implementation in an outside plant (OSP) environment.

In accordance with a second aspect of the present invention there is provided a WDM channel of an optical network, the method comprising the steps of applying a rate multiplying line code to an electrical transmit data signal prior to conversion of the electrical transmit data signal into an optical WDM channel data signal, applying a corresponding rate dividing line code to an electrical receive data signal converted from a received optical WDM channel data signal, and generating an embedded optical channel (EOC) signal in a portion of a bandwidth of the WDM channel for transmission of network management data, wherein the rate multiplying line code is not applied if the electrical transmit data signal is of a protocol satisfying a threshold condition and is applied if the electrical transmit data signal is of another protocol not satisfying the threshold condition, wherein the corresponding rate dividing line code is not applied to WDM channel signals originating from electrical transmit signals satisfying the threshold condition and is applied to WDM channel signals originating from electrical transmit data signals not satisfying the threshold condition, and wherein the threshold condition is based on interference between the EOC channel signal and the WDM channel data signal.

Preferably, the threshold condition is based on a determination of overlap areas between power density spectra of the EOC signal and the respective unencoded WDM channel data signals. The threshold condition may be based on first ratios of the power in the EOC signal and in said respective overlap areas, and second ratios of the respective powers in the unencoded WDM data signals and in said respective overlap areas.

The threshold condition may comprise the electrical transmitter data signals having a bit rate equal to or lower than the bit rate of a threshold protocol.

In one embodiment, the method comprises the steps of generating an electrical management data signal, combining the electrical transmit data signal with the electrical management data signal and driving a laser element for generating the WDM channel signals with the combined electrical signal.

The method may further comprise extracting an EOC signal from a WDM channel signal received at the network element. The method may comprise extracting the EOC signal utilising an optical tap element disposed in a manner such that a portion of the received WDM channel signal is tapped off for extracting the EOC signal.

The method may comprise extracting the EOC signal utilising an electrical tap element disposed in a manner such that a portion of the electrical receive signal converted from the WDM channel signal is tapped off for extracting the EOC signal.

In one embodiment, the method further comprises generating k-bit status words for transmission in the EOC signal and reading k-bit status words received in the EOC signal.

The method may further comprise selectively generating a management data codeword incorporating the management data or a status codeword incorporating one k-bit status word for transmission on the EOC and selectively extracting a management data codeword or a status codeword word from the EOC signal.

The method may further comprise applying a FEC process to the management data prior to generation of the EOC channel signal and to the received EOC signal.

In one embodiment, the method further comprises applying an EOC rate multiplying line code to the management data prior to generation of the EOC channel signal and applying an EOC dividing line code to the received EOC signal.

In accordance with a third aspect of the present invention, there is provided an optical network comprising one or more network elements of the first aspect.

### BRIEF DESCRIPTION OF THE DRAWINGS

Preferred embodiments of the present invention will now be described, by way of example only, with reference to the accompanying drawings.

FIG. 1 shows a schematic diagram of a node in a WDM network, embodying the present invention;

FIG. 2 shows a detail of the node of FIG. 1;

FIG. 3 shows a detail of FIG. 2 for a network node embodying the present invention;

FIG. 4 shows another detail of FIG. 2, for a network node embodying the present invention;

FIG. 5 shows a data codeword format in an example embodiment;

FIG. 6 shows a status codeword format for an example embodiment;

FIG. 7A to C show the relative spectral power density spectra of an EOC signal and client data signals of different protocols, embodying the present invention;

FIGS. 8A and 8B illustrate a WDM channel plan of an example embodiment;

FIG. 9A shows fibre insertion losses as a function of WDM channel wavelength in an example embodiment;

FIG. 9B shows optical losses as a function of WDM channel wavelength as a result of tapping off for EOC extraction and further accounting for a noise impact of the EOC, in an example embodiment;

FIG. 9C shows insertion losses as a function of WDM channel wavelength during multiplexing and demultiplexing in an example embodiment;

FIG. 9D shows received power levels as a function of WDM channel wavelength in an example embodiment.

FIG. 10 shows a detail of FIG. 1 in an alternative embodiment.

### DETAILED DESCRIPTION OF THE EMBODIMENTS

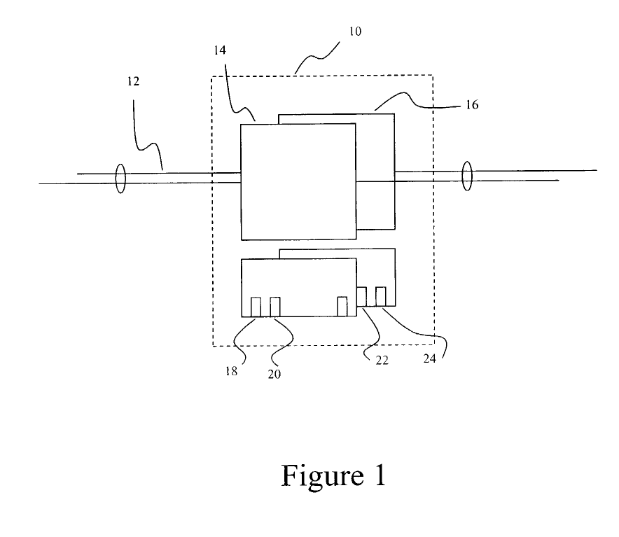

FIG. 1 shows schematically a node 10 on a bi-directional WDM link 12 which can form part of an optical ring or spur network. The bi-directional WDM link 12 can be a single-fibre or a two-fibre transmission link.

The node 10 comprises a west to east add/drop section 14, and an east to west add/drop section 16. It is noted that while the add/drop section 14, 16 are shown as “separate” functional components in FIG. 1, they may physically be implemented either as separate modules or as an integrated module.

The node 10 further comprises multiple client or tributary interfaces and associated input signal encoders e.g. 18, 20 and output signal decoders e.g. 22, 24—one each per wavelength channel (labelled 1-p).

Each encoder e.g. 18, 20 can selectively encode a client data stream intended for transmission from node 10 (eg, I₁₁) using a rate multiplying code such as bi-phase, or bypass the native client protocol without additional encoding. The latter encoder-bypass option is used if the client data rate is equal to or greater than the bit rate of a protocol satisfying a threshold condition, in the example embodiment client data having OC3 or higher data rates.

At the other end of the transmission link, the associated client egress interface would decode the stream received from the WDM network at a decoder, or it would bypass the decoder (if not encoded by the ingress interface) to transparently pass the native data stream to a client output port.

Further details of example implementations of suitable encoder and decoder designs are described in U.S. patent application entitled “Jitter control in optical network”, filed on May 13, 2002 and assigned to the assignee of the present application, the content of which is hereby incorporated by cross-reference.

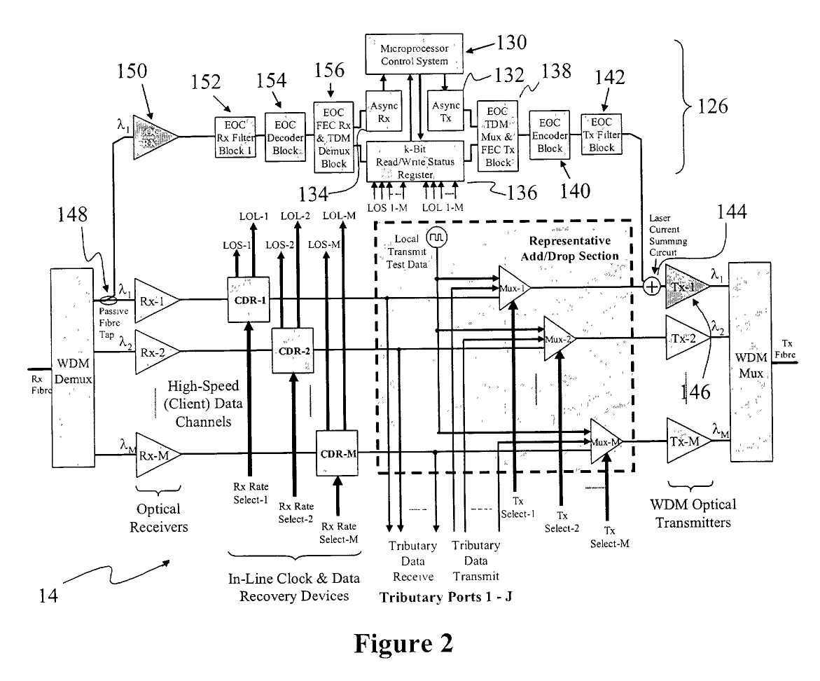

In the following, details of the west to east add/drop section 14 will be described with reference to FIGS. 2 to 4.

In FIG. 2, the west to east add/drop section 16 comprises a management unit 126 including a micro-processor control system 130. The microprocessor control system controls a universal asynchronous transmitter element 132 and a universal asynchronous receiver element 134. It further controls a k-bit read/write status register 136. A codeword generator in the form of a time division multiplexed (TDM) multiplexer and forward error correction (FEC) unit 138 selectively generates a data codeword containing management data from the universal asynchronous transmitter 132 or a status codeword containing a k-bit status word from the status register 136.

The management unit 126 further comprises a rate multiplying encoder block 140 for encoding the codeword stream generated by the TDM multiplexer and FEC unit 138. The encoded EOC data passes to a current source 142 with first order low-pass filter characteristics to generate an EOC modulated laser current which is directed towards a summing circuit 144 to be combined with an electrical client data signal to drive one of the WDM lasers 146 for creating the optical WDM channel signal containing both the client data and the EOC signal.

On the receiving side of the management unit 126, a passive optical fibre tap 148 is utilised to tap off a portion of a received WDM channel signal. The tapped off portion is directed to an optical receiver and amplifier unit 150 for conversion into a corresponding electrical signal. The converted electrical signal is filtered in EOC rx filter unit 152 prior to being decoded in EOC decoder unit 154. The decoded EOC data is then fed to an EOC TDM demultiplexer and FEC receiver unit 156, for selectively forwarding management data to the universal asynchronous receiver 134 or a status word to the status register 136.

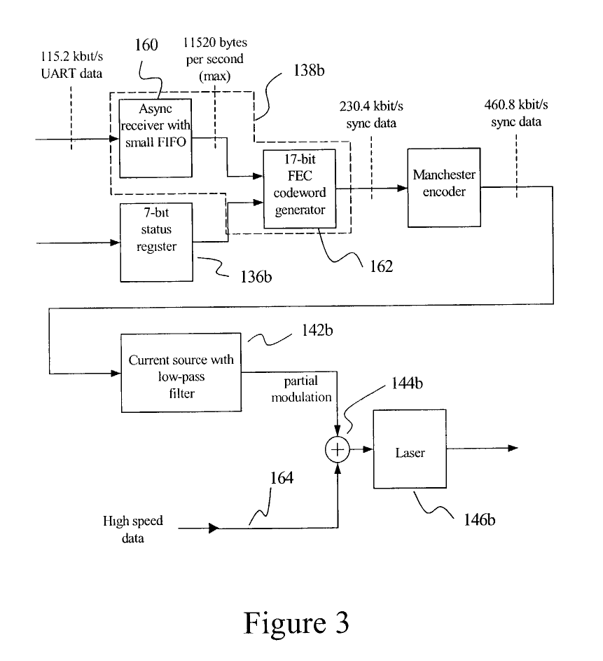

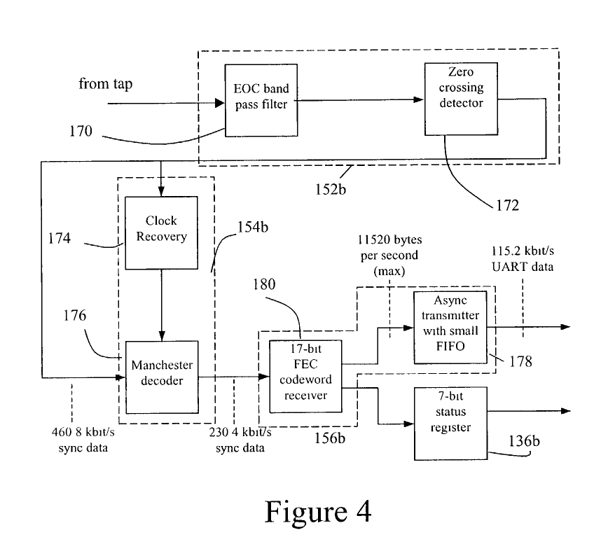

Further details of the transmitting and receiving side of the management unit 126 will now be described with reference to FIGS. 3 and 4 respectively.

In the example embodiment shown in FIG. 3, the status register is in the form of 7-bit register 136b. The TDM multiplexer and FEC unit 138b comprises an asynchronous receiver with small FIFO (First In First Out) 160, and a 17-bit FEC codeword generator 162.

The encoder block is in the form of a bi-phase-level (Manchester) encoder 140b, and the current source is in the form of a current source with a low-pass filter 142b set for a partial modulation of the high speed data laser modulator signal at numeral 164 when combined in the adder circuit 144b, for driving the WDM laser 146b.

Turning now to FIG. 4, on the receiving side of the management unit 126 (FIG. 2), in the example embodiment the EOC rx filter unit 152b comprises a bandpass filter 170 and a zero crossing detector 172. The EOC decoder unit 154b comprises a clock recovery unit 174 and a Manchester decoder unit 176. The EOC TDM demultiplexer and FEC receiver unit 156b comprises an asynchronous transmitter with small FIFO (First In First Out) 178 and a 17-bit FEC codeword receiver 180. The status register is the 7-bit status register 136b (compare FIG. 3).

In the example embodiment described with reference to FIGS. 3 and 4, the universal asynchronous receiver transmitter data is clocked at 115.2 kbit/seconds. The coded data (prior to the encoding) is transmitted at 230.4 kbit/seconds. With the data arriving at 11520 bytes per second, and with a FEC codeword rate of 230400/17=13553 codewords per second, there is a maximum of 17 data bytes for every 20 codeword slots.

Whenever there is no management data to be encoded, a status codeword will be transmitted. To distinguish between a datacode and a status codeword, the first transmitted bit will be zero for data codewords and one for status codewords in the example embodiment. When data codewords are being transmitted at their maximum rate, three in every twenty codeword slots will be available for transmitting status codewords. When no data codewords are being transmitted, every codeword will be a status codeword in the example embodiment.

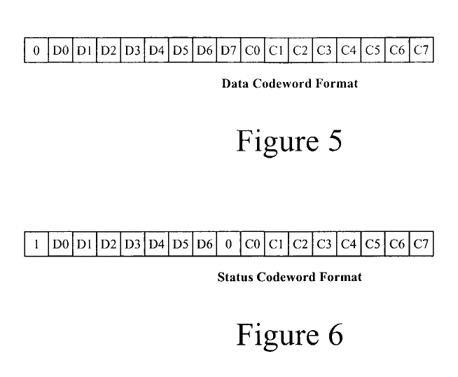

To be able to delineate codewords, the status codewords preferably never contain all ones nor all zeros. A codeword will be all zeros in the example embodiment if the nine data bits are all zero. The codeword will be all ones if the nine data bits are all ones. For this reason, the ninth bit of the status codeword in the example embodiment will always be a zero. Note that it is possible for consecutive data codewords to contain all zeros, but a status codeword will be transmitted after at most six consecutive data codewords, and hence it will be possible to delineate codewords even in the presence of data codewords in the example embodiment. The codeword formats are shown in FIGS. 5 and 6 for data codewords and status codewords respectively.

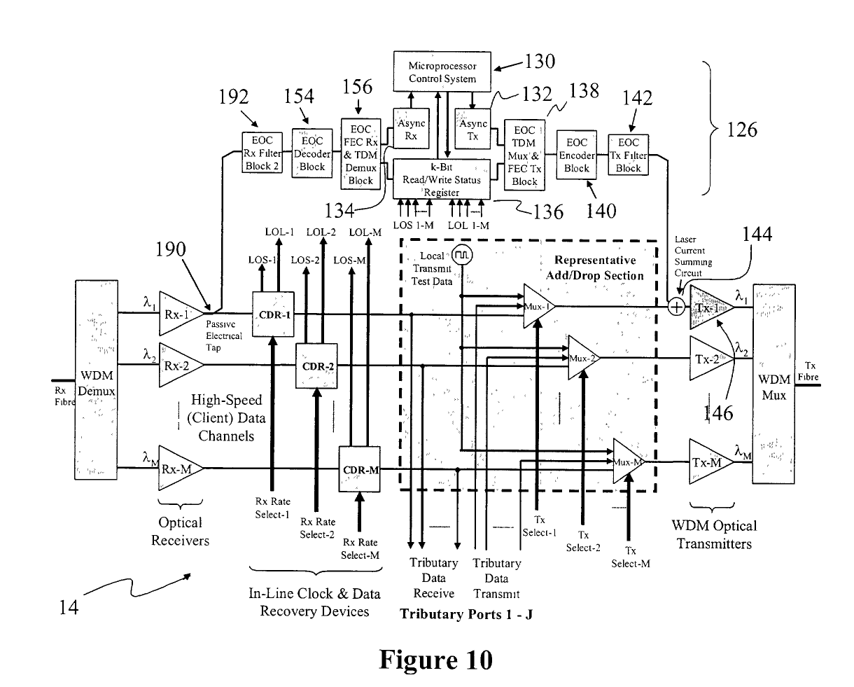

FIG. 10 shows another example embodiment for implementation of the west to east add drop section 14 (FIG. 1). In that embodiment, a passive electrical tap 190 is utilised to tap off a signal portion for extraction of the EOC signal. Consequently, no EOC Rx optical receiver is required, but rather the tapped off electrical signal is fed directly into an EOC RX filter unit 192. The remainder of the functional block are the same as for the embodiment shown in FIG. 2, and the same reference numerals have been used in FIG. 10 for their identification.

It will be appreciated by a person skilled in the art that the corresponding east to west section 16 (FIG. 1) is essential “mirrored” designs of the west to east sections 14 shown in different embodiments in FIGS. 2 and 10.

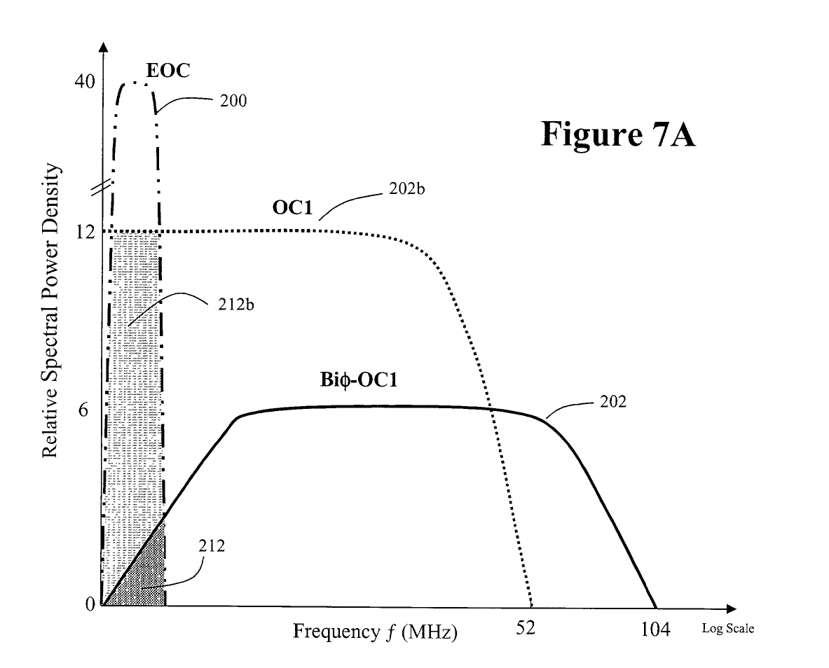

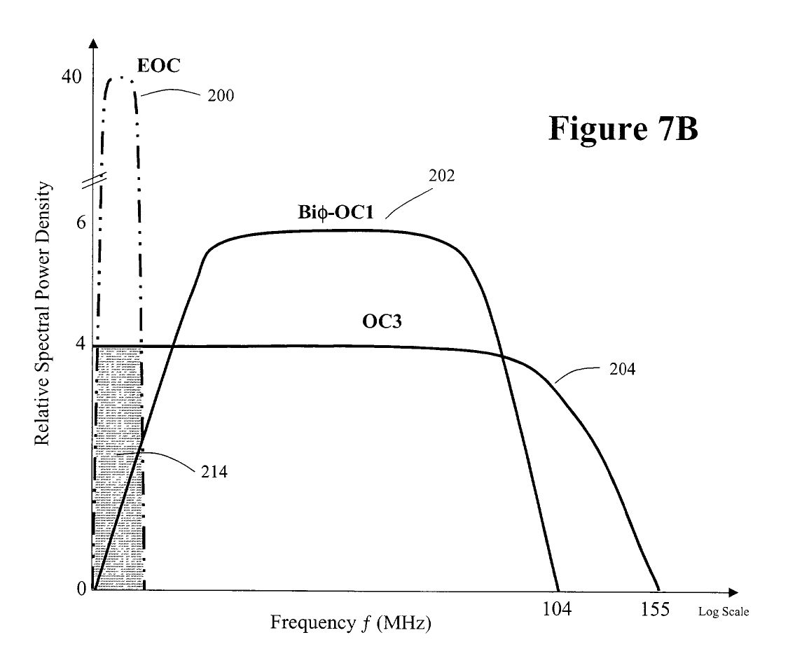

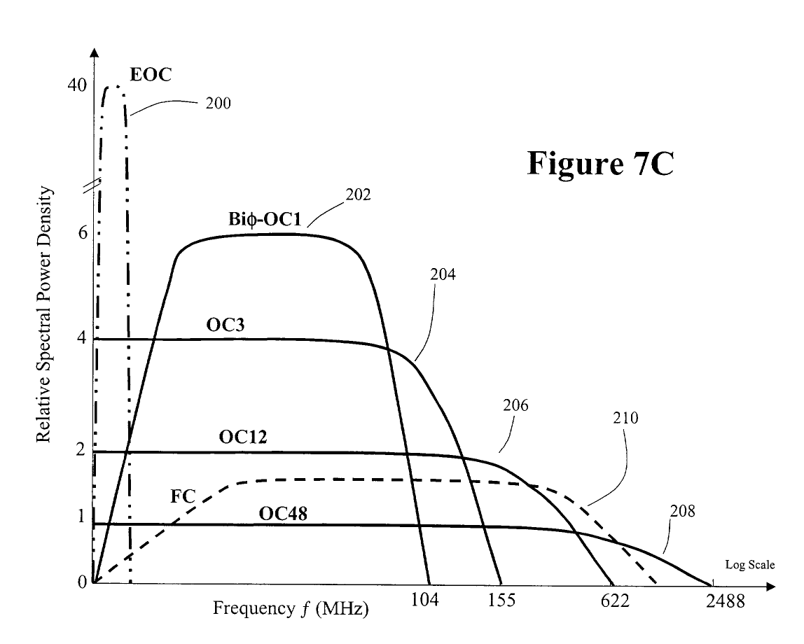

FIGS. 7A to C show schematically the relative spectral power densities between the EOC signal 200 and client data signals of differing protocols 202, 204, 206, 208 and 210 for the example embodiment. It will be appreciated by a person skilled in the art that, at any one time the EOC signal 200 “co-exists” with client data of one protocol only on a particular WDM channel.

As discussed above with reference to FIG. 1, for client data of a protocol having a rate below the threshold protocol OC3, e.g. OC1, that client data has been encoded with a rate-multiplying line code, in the example embodiment bi-phase encoded, resulting in a spectral power density curve 202. As can be seen in FIG. 7A, the resulting overlap area 212 has been reduced when compared with an “original” overlap area 212b between the EOC signal 200 and the unencoded OC1 signal 202b shown in a dotted line for comparison.

For client data of a protocol having a rate equal to or greater than the OC3 threshold, e.g. for OC3 curve 204 in FIG. 7B, that client data has not been encoded and thus maintains its “original” low frequency content. An option to reduce low frequency content in the EOC band is AC couple the data transmission

It will be appreciated by the person skilled in the art that in the absence of AC coupling, the degradation of the EOC signal that is caused by the larger overlap area can be compensated for by the use of an appropriate FEC code.

It will be appreciated by the person skilled in the art that, for a given total optical power in each of the client data spectra, the lower frequency power density for OC3 is less than for lower rate client data protocols such as OC1. As a result, the overlap area 214 between the EOC signal 200 and the OC3 signal 204 is smaller than the corresponding overlap area 212b (FIG. 7A) for unencoded OC1.

It has been recognised by the applicant that if OC3 and higher rate client data protocols were also encoded, that would increase the required processing power to an extent that heat generated from the processing components can make implementation in an OSP situation very difficult, if not impossible.

At the same time, it has been recognised that for those higher rate data protocols, reduction of the low frequency content is not required in order to facilitate implementation of an EOC that can satisfy transmission and noise requirements. In the example embodiment, a threshold condition is based on first ratios of the total power in the EOC signal, i.e. the area under curve 202, and the power in/size of the overlap area, e.g. 214, and second ratios between the total power in the client data signals, i.e. the area under e.g. curve 204, and the power/size of the overlap area e.g. 214. It will be appreciated by the person skilled in the art that the respective ratios are a measure for meeting bit error and signal to noise ratio requirements in the EOC and client data signals.

It further has been recognised that for higher rate data protocols, the low frequency power density is reduced compared with lower frequency data protocols for a given optical power in the data spectra as mentioned above. As such, once a threshold protocol has been found that satisfies the transmission and noise requirements, in the example embodiment OC3, those requirements will also be met for data protocols of higher rates such as OC12 or OC48 (spectra 206, 208 in FIG. 7C) since low frequency contents will be further reduced. It is noted that the determination of the threshold protocol in the example embodiment is not only dependent on the bit rate of the various protocols. Rather, both the bit rate and a consecutive identical digits (CID) duration of the protocol are considered in determining the interference between the EOC and the client data signals, i.e. they are reflected in the power density spectra 202, 204, 206, 208 and 210 in FIGS. 7A to C.

Accordingly, an optimisation process has been recognised which involves balancing interference between the EOC signal 200 and various encoded and unencoded data signals on the one hand, and processing power required for the encoding on the other, in meeting transmission and noise requirements in an OSP environment.

Also shown in FIG. 7C is the Fibre Channel (FC) protocol spectrum 210. Since FC has a frequency greater than that of OC3, it is not encoded at the client interface to the WDM network in the example embodiment. However, as FC is inherently 8B/10B encoded, similar to Gigabit Ethernet, the initial rise region from DC in the spectrum 210 is due to the inherent characteristics of FC, and not encoding at the client interface, which, as mentioned above does not occur for FC in the example embodiment.

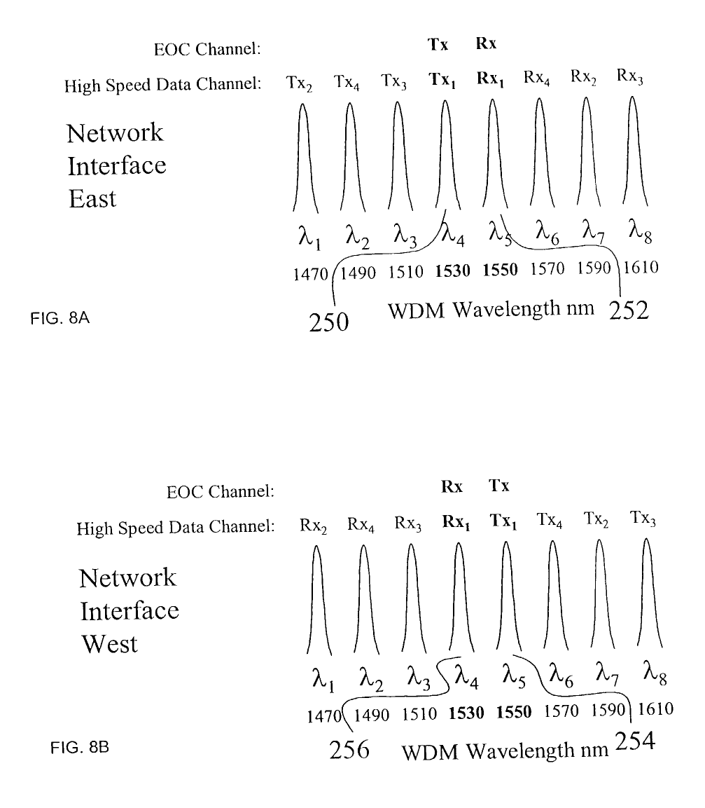

FIGS. 8A and B illustrates a representative WDM channel plan for transporting up to four bi-directional high speed (client) data channels and a bi-directional EOC channel over a single-fibre WDM network embodying the present invention. It is noted that the number of channels and wavelengths is arbitrarily chosen for the example embodiment, and a larger or smaller number can be used without effecting the nature of this invention.

As shown in FIG. 8A, the EOC channel is sub-carrier multiplexed with the high speed data associated with channel 1, i.e. EOC Tx on Tx₁ signal 250 at λ₄, and EOC Rx on Rx₁ 252 at λ₅.

At the network interface west, FIG. 8B, the EOC Tx on Tx₁ signal 254 at λ₅, and EOC Rx on Rx₁ 256 at λ₄. The encoding format and rate of the high speed data can vary widely across the range DC to 2.5 Gbit/s in the example embodiment. It is further noted that the representative mapping of channels to wavelength as shown in FIG. 8 is arbitrarily chosen for the example embodiment and does not effect the nature of this invention. It is further noted that the multiplexing of the high speed data and EOC channels can also be onto a bi-directional two-fibre transmission link, i.e. a transmission link in which each fibre is uni-directional. The implementation differences between these two options, which do not effect the nature of the invention, include that for the single-fibre option, the EOC-west transmit wavelength is different to the EOC-east transmit wavelength (see above), and for the same number of high speed data channels N, the single-fibre option requires twice as many wavelengths per fibre compared to the two-fibre option.

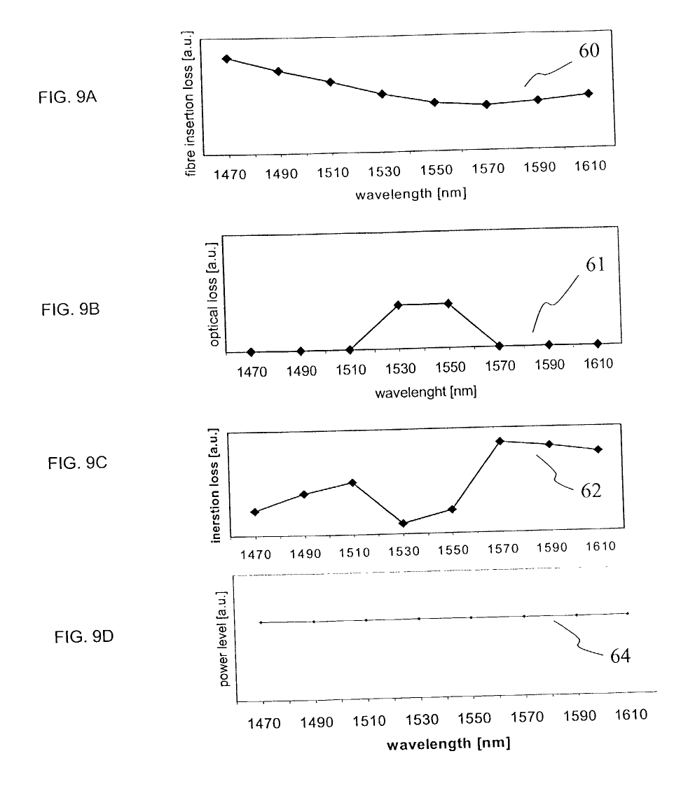

FIGS. 9A-D summarise a transmission link design between adjacent nodes in an example embodiment of the present invention. In FIG. 9A, plot 60 shows the fibre insertion loss as a function of WDM signal wavelength for a transmission link of 20 km. FIG. 9B shows effective losses (plot 61) for the wavelength channels at 1530 nm and 1550 nm due to the tapping off from those channels for extraction of the EOC signal (compare description above with reference to FIGS. 2 to 4). It will be appreciated by the person skilled in the art that each of the WDM signals at 1530 and 1550 nm experiences one tap at the one node of the pair of nodes linked by the transmission link at which the respective WDM signal is received.

In the example embodiment, a noise impact of the EOC signal on the WDM channels at 1530 nm and 1550 nm is also accounted for in the power balancing.

In FIG. 9C, plot 62 shows the insertion losses experienced by the individual WDM signals in the multiplexing/demultiplexing at the nodes linked by the transmission link. Losses during multiplexing for transmission from the one node and losses due to demultiplexing for receiving at the other node are combined for each of the WDM signals.

In the example embodiment, the transmission link design is chosen such that the overall result (i.e. the combination of the losses shown in FIGS. 9A-C) is that the dynamic range between the WDM signals is minimised. This is illustrated by the substantially horizontal plot 64 in FIG. 9D.

It will be appreciated by the person skilled in the art that there is a number of further optical losses experienced by the individual WDM channel signals, which can be considered for the balancing in different embodiments of the present invention. Those further optical losses include e.g. effective optical losses as a result of the sensitivity of the channel receiver units. Furthermore, it will be appreciated that the optimisation processes described in this specification in preferred embodiments can facilitate reaching design targets such as maximising transmission distance, compensating for potential degradation due to the EOC/data multiplexing, maximising EOC bit rate, broadening operating temperature range, and minimising costs.

It will be appreciated by the person skilled in the art that numerous modifications and/or variations may be made to the present invention as shown in the specific embodiments without departing from the spirit or scope of the invention as broadly described. The present embodiments are, therefore, to be considered in all respects to be illustrative and not restrictive.

In the claims that follow and in the summary of the invention, except where the context requires otherwise due to express language or necessary implication the word “comprising” is used in the sense of “including”, i.e. the features specified may be associated with further features in various embodiments of the invention.

1. A network element for use in a multi-protocol WDM network, the network element comprising:
a rate multiplying encoding unit for applying a rate multiplying line code to an electrical transmit data signal prior to conversion of the electrical transmit data signal into an optical WDM channel data signal,
a rate dividing decoding unit for applying a corresponding rate dividing line code to an electrical receive data signal converted from a received optical WDM channel data signal, and
a management unit arranged, in use, to generate an embedded operational channel (EOC) signal in a portion of a bandwidth of the WDM channel for transmission of network management data,
wherein the encoding unit is arranged such that, in use, the rate multiplying line code is not applied if the electrical transmit data signal is of a protocol satisfying a threshold condition and is applied if the electrical transmit data signal is of another protocol not satisfying the threshold condition,
wherein the decoding unit is arranged such that, in use, the corresponding rate dividing line code is not applied to WDM channel data signals originating from electrical transmit data signals satisfying the threshold condition and is applied to WDM channel data signals originating from electrical transmit signals not satisfying the threshold condition, and
wherein the threshold condition is based on interference between the EOC channel signal and the WDM channel data signals.

2. A network element as claimed in claims 1, wherein the threshold condition is based on a determination of overlap areas between power density spectra of the EOC signal and the respective WDM channel data signals.

3. A network element as claimed in claim 2, wherein the threshold condition is based on first ratios of the power in the EOC signal and in said respective overlap areas, and second ratios of the respective powers in the unencoded WDM data signals and in the respective overlap areas.

4. A network element as claimed in claims 2 or 3, wherein the threshold condition comprises the electrical transmit data signals having a bit rate equal to or lower than the bit rate of a threshold protocol.

5. A network element as claimed in claim 1, wherein the network element comprises a laser element for generating the WDM channel signals, and the management unit comprises means for generating an electrical management data signal, and the interface structure is arranged, in use, to combine the electrical transmit data signal with the electrical management data signal and to drive the laser element with the combined electrical signal.

6. A network element as claimed in claim 1, wherein the management unit is further arranged, in use, to extract an EOC signal from a WDM channel signal received at the network element.

7. A network element as claimed in claim 6, wherein the management unit comprises a tap unit for extracting the EOC signal.

8. A network element as claimed in claim 7, wherein the tap unit comprises an optical tap element disposed in a manner such that, in use, a portion of the received WDM channel signal is tapped off for extracting the EOC signal.

9. A network element as claimed in claim 7, wherein the tap unit comprises an electrical tap element disposed in a manner such that, in use, a portion of the electrical receive signal converted from the WDM channel signal is tapped off for extracting the EOC signal.

10. A network element as claimed in claim 1, wherein the management unit further comprises a k-bit status register unit for generating k-bit status words for transmission in the EOC signal and for reading k-bit status words received in the EOC signal.

11. A network element as claimed in claim 10, wherein the management unit further comprises a codeword multiplexing unit for selectively generating a management data codeword incorporating the management data or a status codeword incorporating one k-bit status word for transmission on the EOC and a codeword demultiplexing unit for selectively extracting a management data codeword or a status codeword word from the EOC signal.

12. A network element as claimed in claim 1. wherein the management unit is further arranged such that, in use, a forward error correction (FEC) process is applied to the management data prior to generation of the EOC channel signal and to the received EOC signal

13. A network element as claimed in claim 1, wherein the management unit is further arranged such that, in use, an EOC rate multiplying line code is applied to the management data prior to generation of the EOC channel signal and such that an EOC rate dividing line code is applied to the received EOC signal.

14. A method of embedding an optical management channel in WDM channel of an optical network, the method comprising the steps of:
applying a rate multiplying line code to an electrical transmit data signal prior to conversion of the electrical transmit data signal into an optical WDM channel data signal,
applying a corresponding rate dividing line code to an electrical receive data signal converted from a received optical WDM channel data signal, and
generating an embedded optical channel (EOC) signal in a portion of a bandwidth of the WDM channel for transmission of network management data,
wherein the rate multiplying line code is not applied if the electrical transmit data signal is of a protocol satisfying a threshold condition and is applied if the electric transmit data signal is of another protocol not satisfying the threshold condition,
wherein the corresponding rate dividing line code is not applied to WDM channel signals originating from electrical transmit signals satisfying the threshold condition and is applied to WDM channel signals originating from electrical transmit data signals not satisfying the threshold condition, and
wherein the threshold condition is based on interference between the EOC channel signal and the WDM channel data signal.

15. A method as claimed in claim 14, wherein the threshold condition is based on a determination of overlap areas between power density spectra of the EOC signal and the respective WDM channel data signals.

16. A method as claimed in claim 15, wherein the threshold condition is based on first ratios of power in the EOC signal and in said respective overlap areas, and second ratios of the respective powers in the unencoded WDM data signals and in said respective overlap areas.

17. A method as claimed in claims 15 or 16, wherein the threshold condition comprises the electrical transmitter data signals having a bit rate equal to or lower than the bit rate of a threshold protocol.

18. A method as claimed in claim 14, wherein the method comprises the steps of generating an electrical management data signal, combining the electrical transmit data signal with the electrical management data signal and driving a laser element for generating the WDM channel signals with the combined electrical signal.

19. A method as claimed in claim 14, wherein the method further comprises extracting an EOC signal from a WDM channel signal received at the network element.

20. A method as claimed in claim 19, wherein the method comprises extracting the EOC signal utilising an optical tap element disposed in a manner such that a portion of the received WDM channel signal is tapped off for extracting the EOC signal.

21. A method as claimed in claim 19, wherein the method comprises extracting the EOC signal utilising an electrical tap element disposed in a manner such that a portion of the electrical receive signal converted from the WDM channel signal is tapped off for extracting the EOC signal.

22. A method as claimed in claim 14, wherein the method further comprises generating k-bit status words for transmission in the EOC signal and reading k-bit status words received in the EOC signal.

23. A method as claimed in claim 22, wherein the method further comprises selectively generating a management data codeword incorporating the management data or a status codeword incorporating one k-bit status word for transmission on the EOC and selectively extracting a management data codeword or a status codeword word from the EOC signal.

24. A method as claimed in claim 14, wherein the method further comprises applying a FEC process to the management data prior to generation of the EOC channel signal and to the received EOC signal.

25. A method as claimed in claim 14, wherein the method further comprises applying an EOC rate multiplying line code to the management data prior to generation of the EOC channel signal and applying an EOC dividing line code to the received EOC signal.

26. An optical network element as claimed in claim 1, wherein the network element is capable of implementation in an outside plant (OSP) environment.

27. An optical network comprising one or more network elements as claimed in claim 1.
